(19) United States
(12) Patent Application Publication
(10) Pub. No.: US 2007/0177324 A1
(43) Pub. Date: Aug. 2, 2007

(54) Overload release

(76) Inventor: Alf Wabner, Amberg (DE)

Correspondence Address: HARNESS, DICKEY & PIERCE, P.L.C., P.O.BOX 8910, RESTON, VA, 20195, US

(21) Appl. No.: 10/592,770

(22) PCT Filed: Mar. 15, 2004
(86) PCT No.: PCT/DE04/00520

§ 371 Date: Sep. 14, 2006

(51) Int. Cl. H02H 5/04

(52) U.S. Cl. 361/103

(57) ABSTRACT

An overload release is disclosed for interrupting a load current circuit. The release includes an electronic processing unit that generates a current signal according to the current in the load circuit, and a thermomechanical release that releases a switch latch according to the received current signal.

### PRIORITY STATEMENT

This application is the national phase under 35 U.S.C. § 371 of PCT International Application No. PCT/DE2004/000520 which has an International filing date of Mar. 15, 2004, which designated the United States of America, the entire contents of which are hereby incorporated herein by reference.

### FIELD

The invention generally relates to an overload release for disconnection of a load circuit in the event of overloading.

### BACKGROUND

Overload releases are used in switching devices with a protective function, in a known manner.

When switching devices are used in a main circuit, a distinction is drawn between switching devices for switching during operation, and switching devices for switching in the event of a fault. Switching in the event of a fault includes switching as a result of an overcurrent or of a short circuit. Since an overcurrent may occur during operation, for example, during starting of a motor, this must be tolerated for a specific time, in contrast to a short circuit. A short circuit cannot be an operating state. Apart from considerations relating to selectivity, the circuit must be interrupted immediately in this case. In the overload region, the current must continue to pass for a specific time. The length of the time period is dependent on the magnitude of the current, the nature and the characteristic of the load. If a fault occurs, the current-flow duration of the overcurrent will exceed the predetermined value. The circuit must then be interrupted.

If one phase in a three-phase mains system fails, a fault occurs if the load is a motor. Even if the current in the two remaining phases does not exceed the maximum permissible rated current, it must be disconnected.

The distinction between the operating state and the faulty state in the event of an overload, the disconnection in the faulty state, and the identification of a phase failure are normally triggered using bimetallic strips. In this case, as shown in the circuit diagram in FIG. 1, the bimetallic strips B are generally heated by the current in the main current path L1, L2, L3. At the same time, the heated bimetallic strips emit heat to the surrounding area. The bimetallic strips are designed in such a manner that, at the rated current, the bending of the bimetallic strips B does not yet lead to tripping of the switching mechanism S. If the bending resulting from an overcurrent flowing for an unacceptably long period of time in one of the plurality of phases exceeds a limit value, the switching mechanism is tripped.

If the difference between the bending extents of the bimetallic strips in the case of phase failure exceeds a limit value, this likewise results in tripping of the switching mechanism S.

In order to match an overcurrent protective device to different load variables, the maximum permissible rated current, that is to say the current at which the appliance will not itself trip after an infinitely long time, is adjustable. However, in the case of the described conventional solution, the adjustment range, which is in the order of magnitude of 1.5:1.0, is only small. DE 35 45 930 A1 discloses a conventional overload release such as this used in a polyphase motor circuit breaker.

Instead of the thermomechanical principle described above, it is known for an electronic principle to be used, in which it is possible to enlarge the adjustment range. FIG. 2 illustrates an outline circuit diagram of the already known electronic solution. In this solution, information about the magnitude of the current in the main circuit L1, L2, L3 is provided by way of a transformer W to an electronic circuit. The distinction between an operating overcurrent and a fault overcurrent is achieved by means of an electronic model of the respective load, for example, of the motor. The rated current is adjusted by shifting the overcurrent time characteristic in the motor model M. At the same time, an unacceptable current difference in the individual phases in the event of a phase failure must be evaluated. If an unacceptable situation is detected in the motor model and/or in the difference-current discrimination D, a signal which is suitable for driving an actuator A in order to trip the switching mechanism must be generated. Electronic tripping circuits such as these are associated with a comparatively high degree of complexity. By way of example, CH 656 262 A5 discloses an electronic tripping circuit for delayed fault-current protective switching.

### SUMMARY

In at least one embodiment of the invention, simple and cost-effective overload identification, and tripping, are provided for a wide rated-current adjustment range.

At least one embodiment of the invention is directed to a method for disconnection of a load circuit in the event of overloading, which allows simple and cost-effective overload identification and tripping, with a wide rated-current adjustment range.

In at least one embodiment of the invention, the simplicity of the solution includes the combination of an electronic component and a thermomechanical component, and this leads to a highly cost-effective solution. The electronic processing unit has an amplifier at whose output the current signal is produced. Phase-failure protection can also be achieved in a simple manner if the electronic processing device has a difference-current device, which produces a difference current signal on the basis of a current difference between at least two of the phases and this difference current signal is used to vary the gain of the amplifier.

One advantageous development of at least one embodiment of the invention includes a current transformer being used in each of the individual phases of the load circuit, and being connected to the electronic processing unit in order to supply the output signal on the secondary side.

Simple adjustment of the tripping of the switching mechanism is ensured by the capability to adjust this by way of the thermomechanical release, at a specific load current, by adjustment of the gain of the amplifier.

The overload release according to at least one embodiment of the invention is advantageously used in a switching device with a protective function.

### BRIEF DESCRIPTION OF THE DRAWINGS

Further advantages and details of the invention will become evident from the following description of the figures of exemplary example embodiments on the basis of the drawings, in conjunction with the patent claims. In the figures:

FIG. 1 illustrates a circuit diagram.

FIG. 2 illustrates an outline circuit diagram of a known electronic solution.

FIG. 3 shows an outline circuit diagram of an overload release according to an embodiment of the invention.

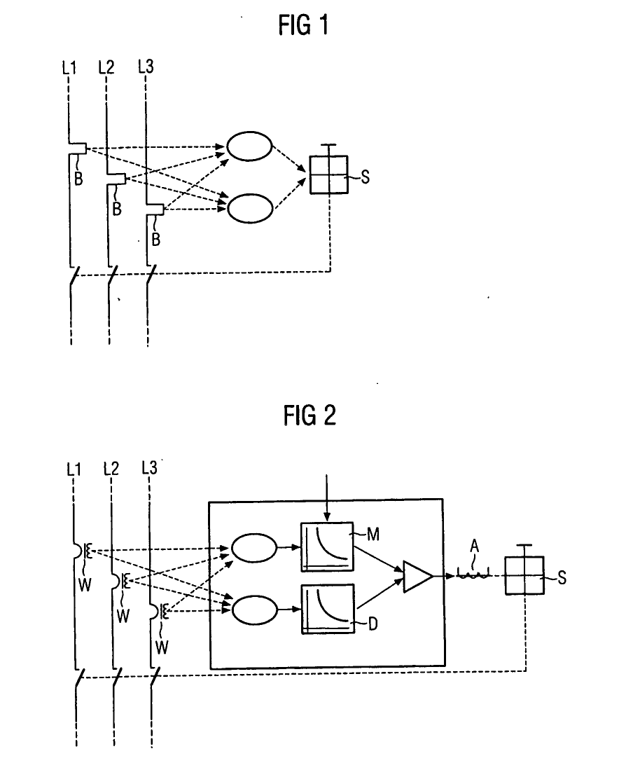

### DETAILED DESCRIPTION OF THE EXAMPLE EMBODIMENTS

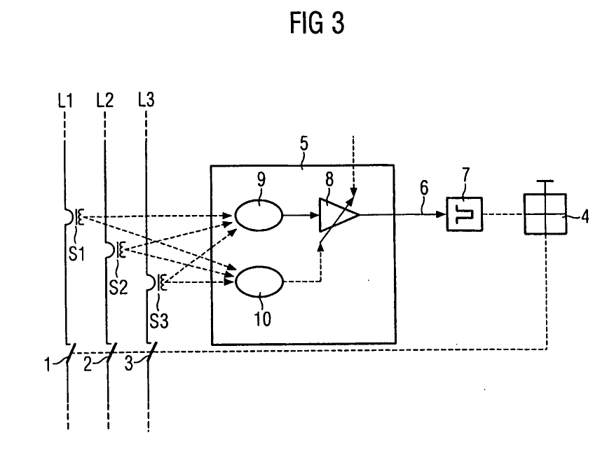

One example embodiment of the invention will be explained in more detail in the following text with reference to FIG. 3.

FIG. 3 shows an outline circuit diagram of an overload release according to an embodiment of the invention, which combines the simplicity of thermomechanical tripping with the wide adjustment range of electronic tripping. In the load circuit to be monitored, which in this case has three phases, a current transformer S1, S2, S3 is used to measure the current in each of the individual phases L1, L2, L3 of the load circuit, and is connected in series with a respective switching element 1, 2, 3. A switching mechanism 4 which is known per se trips as a function of the current load, and this leads to the switching elements 1, 2, 3 disconnecting the current in the phases L1, L2, L3. For this purpose, the secondary sides of the current transformers S1, S2, S3 are connected to an electronic processing unit 5, which receives the transformed currents and generates a current signal 6 which is dependent on them. The current signal 6 controls a thermomechanical release 7, which is connected between the electronic processing unit 5 and the switching mechanism 4. The word control includes, for example, that the magnitude of the current in the heating winding of a bimetallic strip 7 as a thermomechanical release is varied as a function of the current signal 6.

The bimetallic strip 7 is bent as a function of the current flow in the heating winding, and, if the current flow is sufficiently strong, the switching mechanism 4 is tripped in the same way as in conventional circuit breakers.

In principle, it would also be feasible to include further thermomechanical releases 7, although only a single release is used by preference for financial reasons.

The electronic processing unit 5 contains an amplifier 8, which is connected to the secondary sides of the current transformers S1, S2, S3 in order to amplify the output signals, which are proportional to the measured currents in the load circuits L1, L2, L3, and in order to form the current signal 6 for the bimetallic strip 7 from them. In this case, the amplifier 8 is preceded by an OR gate 9.

The bimetallic strip 7 that is used in this way is not itself adjustable. In this case, the rated current is adjusted by the gain of the amplifier 8. Thus, when the gain is low, little gain is applied to the output signal that is emitted from the current transformers S1, S2, S3 to the processing unit 5. The heating power applied to the bimetallic strip 7 is small. A relatively large output signal is therefore required for the bending of the bimetallic strip 7 to reach the value required to trip the switching mechanism 4. In the opposite situation, a high gain is selected. In this case, even comparatively small output signals are sufficient to produce a high heating power for the bimetallic strip 7, and thus to achieve the necessary bending of the bimetallic strip 7 that is required for the tripping of the switching mechanism 4. This allows wide rated-current adjustment ranges of about 4:1 to be achieved.

In summary, with the unchanged adjustment of the bimetallic strip assumed here, the switching mechanism 4 is always tripped at the same heating power, that is to say the same current signal at the output of the amplifier 8. This can be achieved with high gain for a small load current, and in the same manner by low gain with a high load current.

The overload release described above can have phase-failure protection added to it in a simple manner. For this purpose, the output signals on the secondary side are also supplied to a difference-current device 10 in the electronic processing unit 5. The difference-current processing unit 10 identifies a current difference in the phases L1, L2, L3 and in response to this forms a signal which can be used to vary the gain of the amplifier 8. A gain increase is associated with a rise in the bimetallic heating power.

The bimetallic strip 7 bends to a greater extent, thus resulting in earlier tripping of the switching mechanism 4, without the selected rated current being exceeded. In this variant, the bimetallic strip 7 therefore carries out the function of the motor model and that of the difference-current discrimination. The electronics are considerably simplified. Instead of the electronic map of the motor model and of the difference-current discriminator, all that is required is one variable-gain amplifier circuit, which is simple to produce. In contrast to the thermomechanical variant, only one bimetallic strip is required in this case. The actuator which is required in the electronic variant for tripping of the bimetallic strip is likewise superfluous, since this function is also carried out by the bimetallic strip.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An overload release for disconnection of a load circuit in the overload circuit, comprising:
an electronic processing unit to produce a current signal as a function of the current in the load circuit, including an amplifier at whose output the current signal is produced; and
a thermomechanical release to trip a switching mechanism as a function of the current signal, the electronic processing unit further including a difference-current device to produce a difference current signal on the basis of a current difference between at least two phases of the load circuit, the difference current signal being usable to vary a gain of the amplifier.

2. The overload release as claimed in claim 1, wherein a current transformer is used in each of the phases of the load circuit and is connected to the electronic processing unit to supply the output signal on the secondary side.

3. The overload release as claimed in claim 1, wherein the tripping of the switching mechanism by the thermomechanical release at a specific load current is adjustable by adjustment of the gain of the amplifier.

4. The overload release as claimed in claim 1, wherein the thermomechanical release is in the form of a bimetallic strip, to which a heating power, dependent on the current signal, is applied.

5. A switching device, comprising:
an overload release as claimed in claim 1.

6. A method for disconnection of a load circuit in the overload circuit, the method comprising:
transforming a load current in individual phases of the load circuit via a current transformer;
supplying an output signal, produced on a secondary side of the current transformer, to an electronic processing unit in which it is amplified; and
producing, after the amplification, a current signal which is supplied to a thermomechanical release as a tripping criterion for tripping of a connected switching mechanism; and
producing a difference-current signal in the electronic processing unit on the basis of a current difference between at least two of the phases of the load circuit, the difference-current signal being usable to vary a gain of the amplifier.

7. The method as claimed in claim 6, wherein the thermomechanical release is in the form of a bimetallic strip whose heating power is governed by the current signal.

8. (canceled)

9. (canceled)

10. The overload release as claimed in claim 2, wherein the tripping of the switching mechanism by the thermomechanical release at a specific load current is adjustable by adjustment of the gain of the amplifier.

11. The overload release as claimed in claim 2, wherein the thermomechanical release is in the form of a bimetallic strip, to which a heating power, dependent on the current signal, is applied.

12. A switching device, comprising:
an overload release as claimed in claim 1.

13. A switching device, comprising:
an overload release as claimed in claim 2.

14. An overload release for disconnection of a load circuit in the overload circuit, comprising:
means for producing a current signal as a function of the current in the load circuit, the means including an amplifier at whose output the current signal is produced; and
means for tripping a switching mechanism as a function of the current signal, the means for producing further including means for producing a difference current signal on the basis of a current difference between at least two phases of the load circuit, the difference current signal being usable to vary a gain of the amplifier.

15. The overload release as claimed in claim 14, wherein a current transformer is used in each of the phases of the load circuit and is connected to the means for producing a current signal to supply the output signal on the secondary side.

16. A switching device, comprising:
an overload release as claimed in claim 14.

17. A switching device, comprising:
an overload release as claimed in claim 15.
